(19) United States
(12) Patent Application Publication
(10) Pub. No.: US 2008/0234448 A1
(43) Pub. Date: Sep. 25, 2008

(54) Recovery and Washing Process for Polymers

(75) Inventor: David Pratt, Haslemere (GB)

Correspondence Address: NIXON & VANDERHYE, PC, 901 NORTH GLEBE ROAD, 11TH FLOOR, ARLINGTON, VA, 22203, US

(73) Assignee: INEOS EUROPE LIMITED, HAMPSHIRE (GB)

(21) Appl. No.: 11/795,564

(22) PCT Filed: Jan. 6, 2006
(86) PCT No.: PCT/GB06/00044

§ 371 Date: Sep. 18, 2007

(30) Foreign Application Priority Data
Jan. 19, 2005 (GB) 0501102.8

(51) Int. Cl. C08F 2/01; B01J 19/00

(52) U.S. Cl. 526/71; 422/131

(57) ABSTRACT

The present invention relates to a recovery and washing process for polymer materials, in particular to an automated process for recovery and washing of a polymer sample from a high throughput reaction vessel, said process comprising: i) rinsing a polymer sample from a high throughput reaction vessel into a filtration vessel using a rinse liquid comprising a C5 to C8 paraffinic hydrocarbon, and providing in said filtration vessel a mixture comprising the polymer sample, rinse liquid and an oxygenate, ii) removing the rinse liquid and oxygenate from the polymer sample in said filtration vessel by filtration, and iii) subsequently washing said polymer sample in said filtration vessel to remove any residual rinse liquid comprising C5 to C8 paraffinic hydrocarbon.

This invention relates to a recovery and washing process for polymer materials, in particular for polymer samples produced from a high throughput experiment.

Over recent years the advent of combinatorial methods in materials science and of high throughput chemistry techniques, and in particular the growing use of robots and computers to automate catalyst and materials preparation and testing, has allowed researchers to potentially test tens to hundreds to thousands or more catalysts and materials in parallel. Much effort has gone in to developing preparation and testing apparatus for numerous types of materials and material properties (for example U.S. Pat. No. 5,776,359) and, in particular, for chemical reactions of interest (for example see U.S. Pat. No. 5,959,297, U.S. Pat. No. 6,063,633 and U.S. Pat. No. 6,306,658). However as the number of experiments it may be possible to run in parallel has increased so the bottlenecks in catalyst testing have shifted. For example, collecting, handling and storing of experimental data has become an increasingly important area. As a further example, where a researcher had previously to only make, load and test a few catalysts a day or even in a week, the researcher now has to make a much larger number of catalysts to perform the tests on. For high throughput testing of polymerisation processes, in addition to the above issues, the scale (i.e. volume of polymer material produced) has also generally decreased inversely to the increase in number of parallel experiments, giving corresponding difficulties in the handling of the materials produced.

Because of the relatively small scale of high throughput testing, small losses of polymer can cause a big influence on polymer yield. In addition, and perhaps more importantly, although smaller scale analysis methods have been devised, it is still desired to recover as much polymer as possible to ensure as much as possible is available for subsequent analysis. We have now found an improved method for recovering and washing the polymer produced.

Thus, according to the first aspect of the present invention there is provided an automated process for recovery and washing of a polymer sample from a high throughput reaction vessel, said process comprising:
i) rinsing a polymer sample from a high throughput reaction vessel into a filtration vessel using a rinse liquid comprising a C5 to C8 paraffinic hydrocarbon, and providing in said filtration vessel a mixture comprising the polymer sample, rinse liquid and an oxygenate,
ii) removing the rinse liquid and oxygenate from the polymer sample in said filtration vessel by filtration, and
iii) subsequently washing said polymer sample in said filtration vessel to remove any residual rinse liquid comprising C5 to C8 paraffinic hydrocarbon.

It has been found that (small scale) polymer samples from a high throughput reaction vessel can be advantageously recovered and washed using the above process.

The high throughput reaction vessel may be any suitable, relatively small scale, reaction vessel for performing high throughput polymerisation reactions. Typically, the high throughput reaction vessel will be only one of a plurality (an array) of high throughput reaction vessels, such as 8 or more, for example 16 or more reaction vessels, which can operate polymerisation reactions in parallel. The polymer samples from the (each) reaction vessel are generally less than 50 g (washed and dried weight), and more typically less than 25 g, such as in the range 2-25 g, preferably in the range 10-20 g.

Any suitable polymerisation reaction may be performed in the high throughput reactions vessel to form the polymer sample. Preferably, the polymer sample is a polyolefin formed by polymerisation or co-polymerisation of a suitable olefinic monomer or monomers, especially a polyethylene or polypropylene sample.

An example of a suitable high throughput reaction apparatus in which the polymerisations can be performed can be found in WO 01/36087.

At the end of the polymerisation reaction, said polymer samples need to be removed from the reaction vessels (the polymerisation reactions are batch reactions and the polymer samples are therefore products of a batch polymerisation).

Rinse liquids comprising a C5 to C8 paraffinic hydrocarbon have been found to be suitable for removal of all the polymer sample from a high throughput reaction vessel without requiring excessive amounts of rinse liquid, whilst any residual rinse liquid still evaporates quickly enough from the reaction vessel for the vessel to be clean and dry enough for subsequent reactions.

For avoidance of doubt, the rinse liquid is used after formation of the polymer sample to rinse (wash) said sample from the high throughput reaction vessel, and is additional to any reaction media that may be present during the polymerisation reaction to form the polymer sample.

Higher molecular weight hydrocarbons are not suitable as rinse liquids because they are too involatile, and the reaction vessel cannot be dried quickly enough before the next reaction. (Another feature of high throughput experimentation being that it is generally desired to perform as many experiments as possible, and hence it is desired to “turn-around” the reaction vessels for further experiments as quickly as possible.)

The rinse liquid may comprise small amounts, such as less than 10% in total (by volume), of non-C5 to C8 paraffinic hydrocarbons, but preferably comprises less than 5% (by volume), such as less than 1% (by volume) of non-C5 to C8 paraffinic hydrocarbons.

The rinse liquid may be a single C5 to C8 hydrocarbon (by which is meant of at least 95% purity) or may comprise a mixture of C5 to C8 hydrocarbons.

More than one rinse liquid may also be used sequentially.

Although a rinse liquid comprising one or more C5 hydrocarbons may be used in the process of the present invention, C5 hydrocarbons generally have relatively low boiling points (pentane has a boiling point of approximately 35° C.). Hence, C5 hydrocarbons are relatively volatile which can lead to rapid evaporation of the C5 hydrocarbon from the vessel and incomplete washing of the polymer from the reaction vessel. This has the potential disadvantages that not only is not all of the polymer recovered, but that the reaction vessel is not cleaned efficiently (unless significantly larger amounts of C5 hydrocarbon are used, more rinse cycles are performed and/or C6 to C8 hydrocarbons are also present). In addition, it becomes important that washing with C5 hydrocarbons is done in relatively cool reaction vessels, which can slow the overall high throughput process. If the reaction vessel is not cleaned fully this can have a significant effect on subsequent reactions in the reaction vessel.

Hence, preferably the rinse liquid comprises C6 to C8 hydrocarbons, more preferably at least 90% C6 to C8 hydrocarbons (either as a single hydrocarbon or mixture of C6 to C8 hydrocarbons).

A most preferred rinse liquid comprises at least 80% by volume of C7 paraffinic hydrocarbons, and preferably at least 80% by volume of n-heptane.

The polymer sample is rinsed into a filtration vessel using the rinse liquid. The filtration vessel may be any suitable vessel equipped for subsequently allowing filtration. Typically the filtration vessel comprises a main body, which comprises a suitable filter medium such as a frit or filter paper, typically at or close to the base. The top of the filtration vessel may be open to allow introduction of polymer and rinse liquid from the reaction vessel (and subsequent oxygenates and other components as required) or may be closed (or closable) in such a manner so as to allow the vessel to be positively pressurised to push rinse liquid through the filter medium. Preferably, the filtration vessel is adapted to fit over a vacuum or suction pump to draw liquid from the main body through the filter medium at a suitable filtration station.

Preferably, the filtration vessel comprises a suitable seal, which prevents leakage of material from the base of the filtration vessel.

This seal may, for example, comprise a valve which can be opened prior to filtration of material in the vessel.

Preferably, the filtration vessel is adapted to fit over a vacuum or suction pump, and the seal is opened to allow liquid to be removed from the main body by the vacuum or suction pump.

The seal allows the filtration vessel to be used in removal of polymer material directly from a reactor without worrying about rinse liquid leaking onto process equipment as the vessel is moved, for example to a weighing station and/or to a filtration station as described below. Where a weighing station is present, because material cannot leak from the vessel prior to weighing, subsequent weighing will also be a more accurate reflection of the material unloaded from the reactor.

The seal may be a resealable seal, such as a valve. For example, the seal may be a ball valve.

Most preferably, the filtration vessel comprises a breakable seal, which can be broken prior to filtration of material in the vessel.

The seal may be opened (/broken) manually, but preferably is opened automatically. This may be achieved by having an automatic, e.g. computer controlled, means for opening the seal once the filtration vessel is in position for filtration to occur.

Alternatively, the “act” of positioning the filtration vessel for filtration to occur may automatically result in opening of the seal.

For example, the filtration vessel may be adapted to fit over a vacuum or suction pump, and a spring-loaded valve (such as a non-return valve) may be provided at the base of the filtration vessel, and placing the filtration vessel on the pump will provide a force on the valve that results in the opening of the valve.

Where a breakable seal is used, the breakable seal may be any seal which is secure to liquid when in place, but which can be easily broken. Suitable materials for use as the seal, include thin layers of non-porous paper or of plastic.

The seal is broken prior to filtration of material in the filtration vessel, preferably immediately before filtration, and most preferably as the filtration vessel is placed on a suitable filtration station. The seal may be broken by any suitable means, such as a suitably-sized protrusion on which the filtration vessel may be impaled to break the seal, such as a suitable spike.

The filtration medium should be located far enough above the breakable seal such that the breakable seal may be broken without piercing the filtration medium.

The main body of the filtration vessel should be sized to allow the polymer sample and required volumes of rinse and wash liquids, and oxygenate to be held. Generally, the main body can be sized to hold a total volume of 1000 ml or less above the filtration medium, and more typically 500 ml or less, although vessels capable of holding significantly larger volumes than this may also be used. Preferably, the main body can be sized to hold a total volume in the range 20-500 ml, preferably in the range 200450 ml above the filtration medium.

For example, for recovery and washing of a polymer sample of approximately 20 g, the main body may typically need to be sized to hold a total volume of approximately 450 ml above the filtration medium (based on approximately 150 ml of reaction mixture, approximately 150 ml of rinse liquid and approximately 150 ml of oxygenate), although the vessels may be sized differently if differing amounts of rinse liquid and/or oxygenate are used.

The filtration vessel may be reusable. Where the filtration vessel comprises a breakable seal, for example, the main body may be separable from the part of the filtration vessel comprising the breakable seal, such that a new breakable seal may be added and the filtration vessel reused.

Preferably, however, the filtration vessel is single use (disposable).

Preferably the main body is made of plastic or similar non-costly material.

The polymer sample in a filtration vessel should comprise as much of the polymer produced during the high throughput test as possible. Preferably, unloading of the polymer sample from the high throughput reaction vessel into the filtration vessel is achieved using an apparatus comprising a stirrer which facilitates unloading of material as described in WO 2004/078330.

Although it has been found that rinse liquids comprising C5 to C8 hydrocarbons provide advantageous removal of polymer sample from the reaction vessel, one potential disadvantage of rinse liquids comprising C5 to C8 hydrocarbons is that some polymer material may dissolve in the rinse liquid, and this polymer would be lost when the rinse liquid is removed by filtration.

In the present invention this potential disadvantage is mitigated by mixing an oxygenate with the polymer sample/rinse liquid before removal of the rinse liquid (and also the oxygenate) by filtration. The oxygenate mixes with the rinse liquid and causes precipitation of polymer dissolved therein. Any suitable oxygenate that has solubility in the rinse liquid may be used. Generally, however, for oxygenates which are more hydrophobic, larger amounts of the oxygenate will be required to cause precipitation, and, hence oxygenates with relatively short hydrocarbon chains are preferred. Preferably, therefore, the oxygenate has 2 to 8 carbon atoms. Preferably, the oxygenate is selected from one or more of an alcohol, an ether, an aldehyde and a ketone. Most preferably the oxygenate is one or more alcohols having 2 to 5 carbon atoms. For example, the alcohol may be a used as a single alcohol or a mixture of alcohols. Ethanol is most preferred.

The oxygenate may be used in any suitable amount relative to the rinse liquid comprising C5 to C8 hydrocarbons required to cause precipitation. Typically, the weight ratio of rinse liquid to oxygenate is in the range 5:1 to 1:5, preferably 3:1 to 1:1.

In one embodiment of the first step of the present invention mixing of the oxygenate with the polymer sample/rinse liquid may be achieved by providing a filtration vessel comprising the oxygenate, and rinsing the polymer sample with the rinse liquid into the filtration vessel already comprising the oxygenate. In a second, preferred, embodiment, the oxygenate is added to the filtration vessel after the polymer sample has been rinsed into the filtration vessel.

In the second step of the process of the present invention, the rinse liquid/oxygenate is removed from the filtration vessel by filtration. This is preferably achieved by passing the filtration vessel comprising said polymer sample and rinse liquid therein (either before or after the oxygenate is introduced to the filtration vessel) to a filtration station which is capable of removing rinse liquid, and other liquid in the filtration vessel, typically by application of a vacuum below the filtration medium of the filtration vessel.

Preferably the filtration vessel comprising polymer sample and rinse liquid is transferred to a filtration station where the oxygenate (and any subsequent washing components) are subsequently added.

In the third step of the present invention, the filtered polymer sample is subsequently washed, whilst in the filtration vessel, to remove any residual rinse liquid. By “washing” is generally meant adding and removing (filtering) a suitable wash liquid. Any suitable wash liquid may be used, and the preferred wash liquids will typically depend on the type of polymerisation reaction which has been performed in the high throughput reaction vessel. However, in generally suitable wash liquids will be those that will not dissolve any of the polymer sample and, at least for a final wash where more than one wash is performed, wash liquids which are relatively volatile, so that the polymer sample can be dried easily. Therefore, low molecular weight (boiling point 100° C. or less), polar wash liquids are preferred.

Gas phase polymerisation reactions, for example, may have been performed in the presence of a water soluble salt, which it is desired to remove from the polymer. This may be achieved, for example, by washing, preferably several times, such as three times, with a mixture of water and an alcohol, such as a mixture of water and ethanol, followed by a final wash with an alcohol, such as ethanol, alone.

For slurry phase polymerisation reactions, for example, it may be sufficient simply to have a single wash with an alcohol, such as ethanol.

The process of the present invention is automated. By this, is meant that any manipulation (movement) of the filtration vessel is automated, for example performed using a suitable robot, and the addition and removal of the required rinse and wash liquids, and oxygenates during recovery and washing is automated, for example, using a suitable dispensing robot to add wash liquid and oxygenates to the filtration vessel and/or and a suitable automated valve to apply vacuum or suction to the filtration station to remove the liquids therein. The process may all be under the control of a single computer.

In a second aspect the present invention provides a filtration vessel suitable for use in the process of the present invention, said filtration vessel comprising a main body, said main body comprising a filter material in the lower half of the main body, and wherein below the filter material the filtration vessel comprises a breakable seal, which can be broken prior to filtration of material in the vessel.

The filtration vessel is preferably as previously described for the first aspect of the present invention. In particular, the main body is suitably sized to hold a total volume of 1000 ml or less above the filtration medium, and more typically 500 ml or less. Preferably, the main body is sized to hold a total volume in the range 20-500 ml, preferably in the range 200-450 ml above the filtration medium.

In a third aspect the present invention provides a process for formation, recovery and washing of polymer sample from a high throughput reaction vessel, said process comprising the steps of:
a) reacting one or monomers in a batch-mode polymerisation reaction in a high throughput reaction vessel to form a polymer sample, and
b) recovery and washing of said polymer sample from said high throughput reaction vessel as described herein.

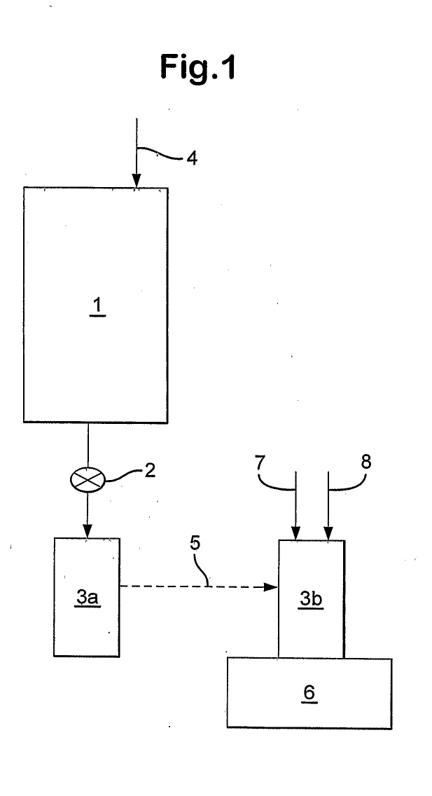

The invention will now be described with respect to FIG. 1, which represents schematically a process according to the present invention.

With reference to FIG. 1, a polymerization reaction is performed in a high throughput reaction vessel (1). At the end of the reaction (which may be terminated for example by adding a quenchant or other reaction poison, or by venting the reaction gases and cooling (not shown)), a valve at the base of the reaction vessel (2) is opened allowing the polymer sample and any other material, such as diluent, in the reaction vessel (1) to pass into a filtration vessel (shown in position 3a) connected thereto. A rinse liquid (4) is used to rinse the reaction vessel (1), thus rinsing polymer sample remaining in the reaction vessel (1) into the filtration vessel (3a). This provides recovery of all the polymer sample whilst also cleaning the reaction vessel.

The filtration vessel containing the polymer sample is transferred using a robotic device (shown by line 5) to a filtration station (6). The new position of the filtration vessel is shown by 3b. An oxygenate (7) is added to the polymer sample and rinse liquid in the filtration vessel (3b) to precipitate any dissolved polymer and provide a mixture comprising the polymer sample, rinse liquid and oxygenate. The liquids are then removed from the mixture by filtration.

The polymer sample is then washed by adding a wash liquid (8) to the filtration vessel (3b) and removing the wash liquid by filtration using the filtration station (6), to give a washed polymer sample.

### EXAMPLES

### Examples of Precipitation of Polyolefin Dissolved in Hydrocarbon by Addition of Oxygenate

Approximately 0.5 g of heptane extractables was redissolved in heptane at 85° C. 10 ml aliquots of the heptane solution were taken and various oxygenated solvents were added to them at room temperature.

The results are shown in Table 1 below:

TABLE 1

| | | Miscible with | Precipitation |
|---|---|---|---|
| Solvent | Volume added | heptane ? | occurred ? |
| Methanol | 5 ml | No | At interface |
| Ethanol | 5 ml | Yes | Yes |
| Propan-1-ol | 5 ml | Yes | Yes |
| Propan-2-ol | 5 ml | Yes | Yes |
| Acetone | 5 ml | Yes | Yes |
| Propan-2-ol and | 2 ml propan-2-ol | Yes | Yes |
| methanol | 1 ml methanol | | |

The above results demonstrate that materials which would dissolve in the hydrocarbon solvent can be precipitated by the addition of suitable oxygenates to the heptane.

### Simulation of Polymer Work-Up According to the Present Invention.

A slurry of 6 g of an ethylene/1-hexene copolymer in 200 ml of heptane was heated, with stirring, for 1 hr in a water bath at 85° C. to simulate the conditions at the end of a typical slurry polymerisation. The resulting viscous solution and suspension of fine polymer particles was then cooled in a cold water bath at 30° C. for 10 minutes with stirring to simulate the procedure typically used in a polymerisation test.

With stirring, ethanol (100 ml) was added to the slightly viscous cloudy suspension by squirting from a syringe. Precipitation of dissolved components occurred to give a suspension of sticky particles in a clear solvent. The sample was filtered, washed with ethanol and dried in an oven overnight at 80° C. to yield 5.74 g of an inhomogeneous elastomeric solid of small particles stuck together by elastomeric material. Thus, over 95% of the original polymer was recovered. (Some material was also lost on the side of the beaker when transferring for filtration.)

The recovered supernatant was clear but when allowed to evaporate yielded 0.06 g of waxy material.

1-12. (canceled)

13. A process for formation, recovery and washing of polymer sample from a high throughput reaction vessel, said process comprising the steps of:
a) reacting one or monomers in a batch-mode polymerisation reaction in a high throughput reaction vessel to form a polymer sample, and
b) recovery and washing of said polymer sample from said high throughput reaction vessel in an automated manner, said recovery and washing process comprising:
(i) rinsing said polymer sample from said high throughput reaction vessel into a filtration vessel using a rinse liquid comprising a CS to C8 paraffinic hydrocarbon, said rinse liquid being additional to any reaction media present during the polymerisation reaction to form the polymer sample, and providing in said filtration vessel a mixture comprising the polymer sample, rinse liquid and an oxygenate, (ii) removing the rinse liquid and oxygenate from the polymer sample in said filtration vessel by filtration, and
(iii) subsequently washing said polymer sample in said filtration vessel to remove any residual rinse liquid comprising CS to C8 paraffinic hydrocarbon.

14. A process as claimed in claim 13, wherein the polymer samples are less than 50 g (washed and dried weight), and more typically less than 25 g.

15. A process as claimed in claim 13, wherein the rinse liquid comprises at least 80% by volume of C7 paraffinic hydrocarbons, and preferably at least 80% by volume of n-heptane.

16. A process as claimed in claim 13, wherein the filtration vessel comprises a main body, said main body comprising a filter material in the lower half of the main body, and wherein below the filter material the filtration vessel comprises a breakable seal, which can be broken prior to filtration of material in the vessel.

17. A process as claimed in claim 16, wherein the main body is sized to hold a total volume of 1000 ml or less above the filtration medium, and more typically 500 ml or less.

18. A process as claimed in claim 13, wherein the oxygenate is a C2 to C5 alcohol.

19. A process as claimed in claim 13, wherein, a low molecular weight polar wash liquid with a boiling point of 100° C. or less, is used to wash the polymer sample in step (iv).

20. A process as claimed in claim 19, wherein the polymer sample is the product of a gas phase polymerisation reaction performed in the presence of a water soluble salt, and wherein the washing comprises washing several times, such as three times, with a mixture of water and an alcohol, such as a mixture of water and ethanol, followed by a final wash with an alcohol, such as ethanol, alone.

21. A process as claimed in claim 19, wherein the polymer sample is the product of a slurry phase polymerisation reaction, and wherein the washing comprises a single wash with an alcohol, such as ethanol.

22. A filtration vessel suitable for use in the process of claim 13, wherein the filtration vessel comprises a main body, said main body comprising a filter material in the lower half of the main body, and wherein below the filter material the filtration vessel comprises a breakable seal, which can be broken prior to filtration of material in the vessel, said filtration vessel being adapted to fit over a vacuum or suction pump and the seal opened to allow liquid to be removed from the main body by the vacuum or suction pump.

23. A filtration vessel as claimed in claim 22, wherein the main body is sized to hold a total volume of 1000 ml or less above the filtration medium, and more typically 500 ml or less.
